(19) United States
(12) Patent Application Publication
(10) Pub. No.: US 2014/0007018 A1
(43) Pub. Date: Jan. 2, 2014

(54) SUMMATION OF TAPPABLE ELEMENTS RESULTS/ACTIONS BY SWIPE GESTURES

(71) Applicants: Nissan Ben Shitrit, Brooklyn, NY (US); Shmuel Elkeslasi, Brooklyn, NY (US)

(72) Inventors: Nissan Ben Shitrit, Brooklyn, NY (US); Shmuel Elkeslasi, Brooklyn, NY (US)

(73) Assignee: FOONCRAZY CORP, Brooklyn, NY (US)

(21) Appl. No.: 13/253,700

(22) Filed: Oct. 5, 2011

(51) Int. Cl. G06F 3/0488

(52) U.S. Cl. CPC G06F 3/0488
USPC 715/863

(57) ABSTRACT

Systems, methods and devices for interpreting swipe gestures over multiple tappable elements, which upon tap operations, perform some action. This allows a user to perform composite actions or results without introducing additional visual elements. For example, performing a swipe gesture over three tappable buttons A, B, C where each tappable button normally shows a subset of records, resulting view would show superset of all three of them, rather then showing button D to perform the same action of showing all of the records. Various other options are described. The described technique can be used in conjunction with various devices, including tablets, personal computers, mobile phones or any device with a touch screen interface.

### CROSS-REFERENCE TO RELATED APPLICATIONS

This is related to the following U.S. patents and patent applications, each of which is hereby incorporated by reference in its entirety: [0002] U.S. Pat. No. 6,323,846, titled “Method and Apparatus for Integrating Manual Input,” issued Nov. 27, 2001; [0003] U.S. patent application Ser. No. 10/840,862, titled “Multipoint Touch screen,” issued May 6, 2004; [0004] U.S. Provisional Patent Application No. 60/804,361, titled “Touch Screen Liquid Crystal Display,” filed Jun. 9, 2006; [0005] U.S. Provisional Patent Application No. 60/883,979, titled “Touch Screen Liquid Crystal Display,” filed Jan. 8, 2007; [0006] U.S. patent application Ser. No. 11/367,749, titled “Multi-functional Hand-held Device,” filed Mar. 3, 2006; [0007] U.S. patent application Ser. No. 11/228,700, titled “Operation of a Computer with a Touch Screen Interface,” filed Sep. 16, 2005; [0008] U.S. Pat. No. 6,677,932, tided “System and Method for Recognizing Touch Typing Under Limited Tactile Feedback Conditions,” issued Jan. 13, 2004; and

[symbol]

### BACKGROUND

The present invention relates generally to input systems, methods, and devices, find more particularly, to systems, methods, and devices for interpreting manual swipe gestures as input in connection with tappable elements in touch-screen.

There currently exist various types of input devices for performing operations in electronic devices. The operations, for example, may correspond to moving a cursor and making selections on a display screen. The operations may also include paging, scrolling, panning, zooming, etc. The input devices may include, for example, buttons, switches, keyboards, mice, trackballs, pointing sticks, joy sticks, touch surfaces (including touch pads and touch screens, etc.), and other types of input devices.

Various types of touch surfaces and touch screens are described the related applications cross-referenced above. Touch screens may include a display, a touch panel, a controller, and a software driver. The touch panel may include a substantially transparent panel that incorporates touch-sensing circuitry. The touch panel can be positioned in front of a display screen or constructed integrally with a display screen so that the touch sensitive surface corresponds to all or a portion of the viewable area of the display screen. The touch panel cap detect touch events and send corresponding signals to the controller. The controller can process these signals and send the data to the computer system. The software driver can translate the touch events into computer events recognizable by the computer system. Other variations of this basic arrangement are also possible.

The computer system can comprise a variety of different device types, such as a pocket computer, handheld computer, or wearable computer (such as on the wrist or arm, or attached to clothing, etc.). The host device may also comprise devices such as personal digital assistants (PDAs), portable media players (such as audio players, video players, multimedia players, etc.), game consoles, smart phones, telephones or other communications devices, navigation devices, exercise monitors or other personal training devices, or other devices or combination of devices.

Recently, interest has developed in touch-sensitive input devices, such as touch screens, for hand-held or other small form factor devices. For example U.S. patent application Ser. No. 11/367,749, titled “Multi-functional Hand-held Device,” discloses a multi-functional hand-held device that integrates a variety of device functionalities into a single device having a hand-held form factor. In such applications, touch screens can be used for a variety of forms of input, including conventional pointing and selection, more complex gesturing, and typing.

### SUMMARY

The present invention can relate to a method of interpreting a swipe gesture over or near by the tappable visual element, while near can be considered as element closest to the detected gesture path. The interpretation may include a variety of operations that combine any actions defined as a response to the tap event of visual elements covered or close to swipe gesture.

With N tappable visual elements usage of swipe gesture in a way described in the present invention X additional possible results can be achieved. Performing the same swipe in the opposite order can give addition X results (FIG. 10).

When we are interested in less than X results, it's possible to extend swipe selection to cover additional elements.

The swipe gesture can cover only a subset of the elements, but the operation might include also additional elements which are located on a way of swipe direction, but not covered by the swipe. This behavior can happen when we are only interested in one operation which should include all the elements (FIG. 20).

The operation performed as the result of swipe gesture can be any defined operation usually performed over the results of elements covered by swipe gesture. Example operations include sum, average, superset, intersection, or any other meaningful operation over the set of results.

Example implementation can be an application for showing a call history on the phone. Application might show button for Incoming/Outgoing/Missed calls. Swiping over all of the buttons might show all records.

Example implementation of using visual operator can be an application for showing a country on virtual globe (FIG. 21). Application might show button for each country. Swiping over part of the buttons or of all of them might show part of the countries or all of them. Another implementation of visual operator describe in (FIG. 22).

Detecting a swipe gesture can include acquiring touch image data from the touch-sensitive device, processing the image to generate one or more finger path events, determining a displacement of the one or more finger path events, and detecting a swipe gesture if the displacement exceeds a predetermined threshold. If the displacement does not exceed the threshold, the input can be interpreted as a conventional tap. The time of the motion associated with the input can also be compared to a maximum swipe gesture timeout threshold. If the timeout threshold is exceeded, the input can be interpreted as a conventional tap.

The present invention can also relate to a computer system including a multi-touch interface that has been adapted and/or programmed to detect and process swipe gesture input in the various ways described above. The computer system can take the form of a desktop computer, a tablet computer, a notebook computer, a handheld computer, a personal digital assistant, a media player, a mobile telephone, and combinations of one or more of these items. The multi-touch interface can include a touch screen.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 depicts a simplified block diagram of a swipe gesture over N tappable elements implementing one or more embodiments of the present invention.

FIGS. 2A-2B depicts a straight swipe gesture over N tappable elements in accordance with an embodiment of the present invention.

FIG. 3 depicts a swipe gesture for any curve and any direction over N tappable elements in accordance with an embodiment of the present invention.

FIG. 4 depicts a circle swipe gesture over N tappable elements in accordance with an embodiment of the present invention.

FIG. 5 depicts an elliptical swipe gesture over N tappable elements in accordance with an embodiment of the present invention.

FIG. 6 depicts a half circle/elliptical swipe gesture over N tappable elements in accordance with an embodiment of the present invention.

FIG. 7 depicts a curve swipe gesture over N tappable elements in accordance with an embodiment of the present invention.

FIG. 8 depicts various operators that may be used in accordance with embodiments of the present invention.

FIG. 9 depicts a result definition of swipe gesture over N tappable elements in accordance with an embodiment of the present invention.

FIG. 10 depicts an additional possible result that can be achieved by swipe gesture over N tappable elements in accordance with an embodiment of the present invention.

FIG. 11 depicts a simplified block diagram of a computer system implementing one or more embodiments of the present invention.

FIG. 12 depicts various computer form factors that may be used in accordance with embodiments of the present invention.

FIG. 13 depicts a database application implementing one or more embodiments of the present invention.

FIGS. 14A-14B depicts a 3D application implementing one or more embodiments of the present invention.

FIGS. 15A-15C depicts a media application implementing one or more embodiments of the present invention.

### DETAILED DESCRIPTION

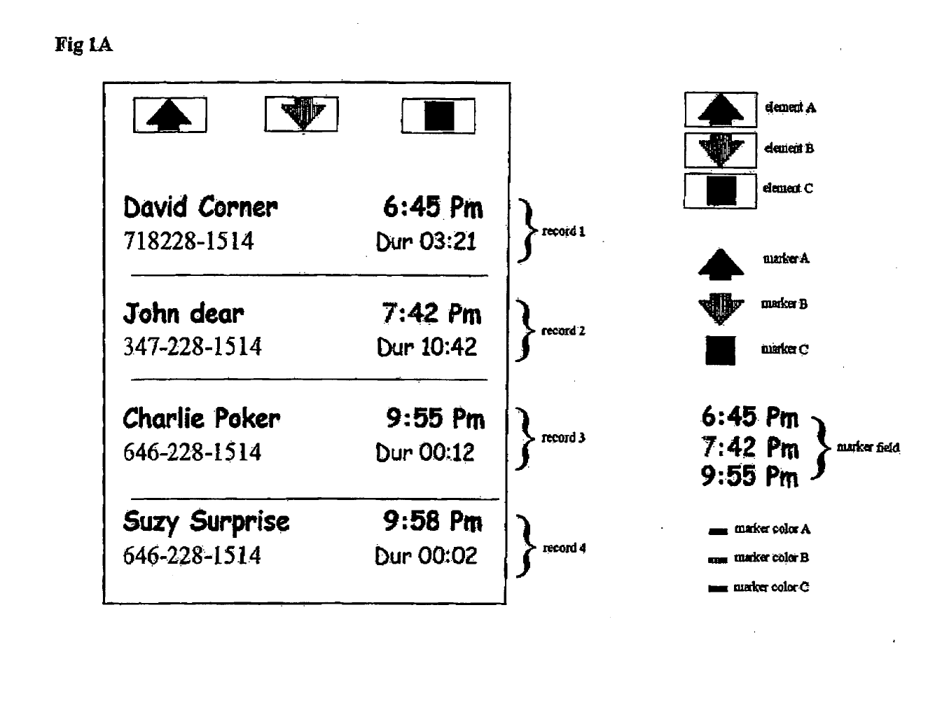

Reference is now made to FIG. 1 which depicts a scheme. The scheme includes N tappable elements. Upon tapping any element, some action is performed and in consequence a result appears.

The action can be a script or sequence of commands or any functions or any procedures. Swipe gestures over N elements that are described generate additional results without using additional tappable elements.

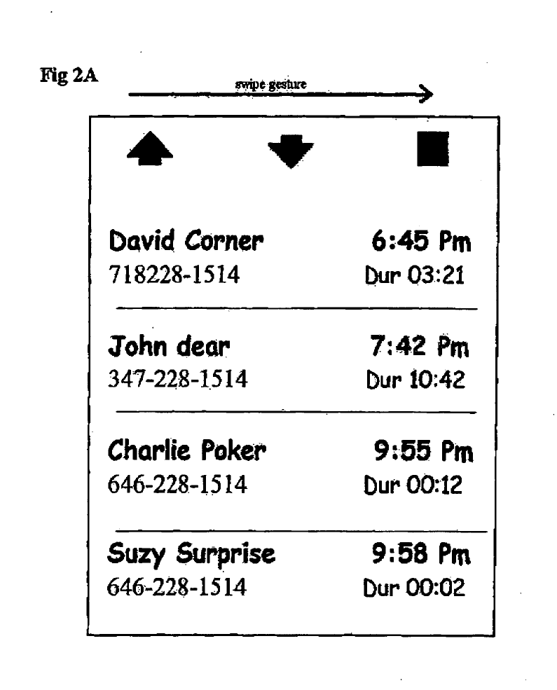

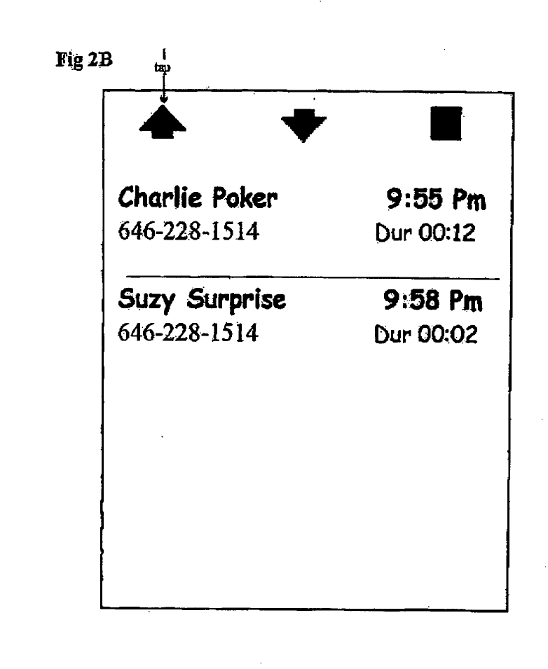

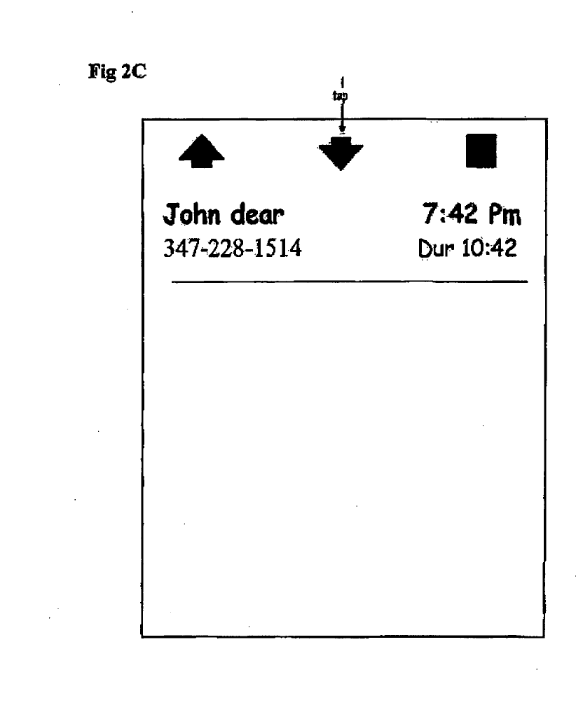

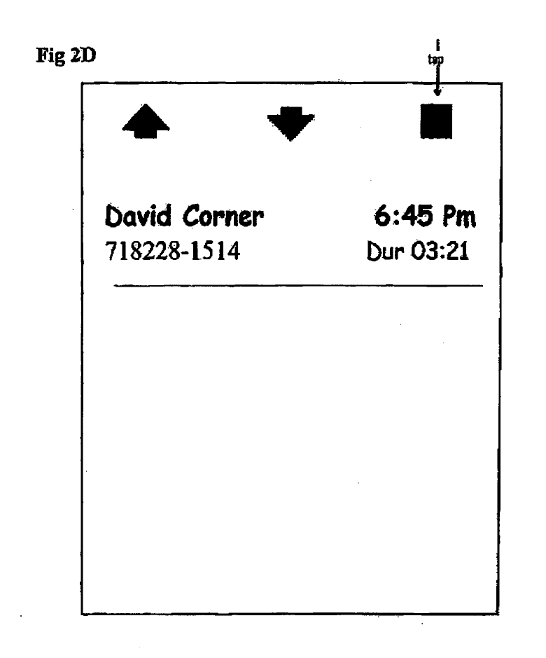

An example of the usage of such swipe gestures can be seen with respect to FIG. 2. The user is finger swiping over N elements located one element near another or located one element upon another.

In each example there is two directions of swipe gesturing over the elements or near them. Each swipe direction generates a result.

The user can swipe near the elements instated of swiping over them till a distance of 10 pixels as described in FIG 2.

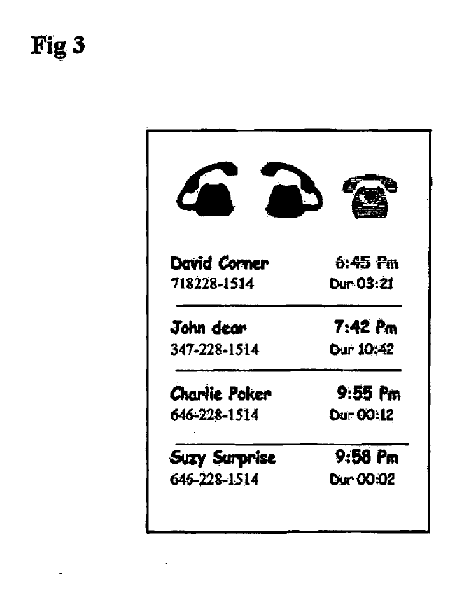

An examples of the usage of such swipe gestures can be seen with respect to FIG. 3 the user is swipe gesturing over N elements located in matrix shape by swiping over part of the elements the user generates additional results except for the regular tappable results.

Any swipe gesture curve at any direction can generate additional results. The user can swipe with his finger straight diagonal and at any curve.

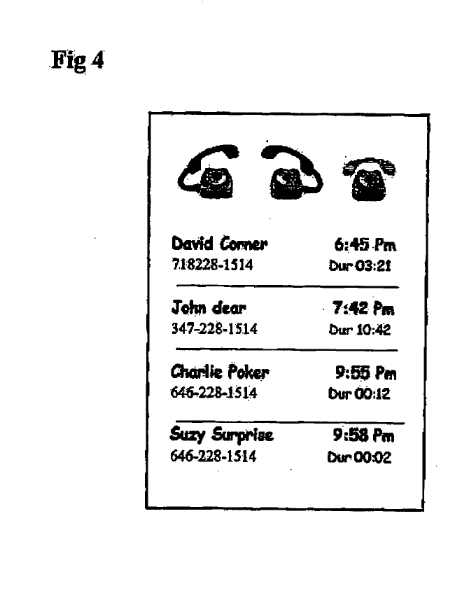

As illustrated in FIG. 4, the user can swipe gesture over N elements but now the elements located in circle shape by swiping clockwise over part of the elements or over all of them the user can generate additional results except for the regular results generated by tapping on the elements. Additional possible results can be achieved by swipe gesturing but now in a counterclockwise direction.

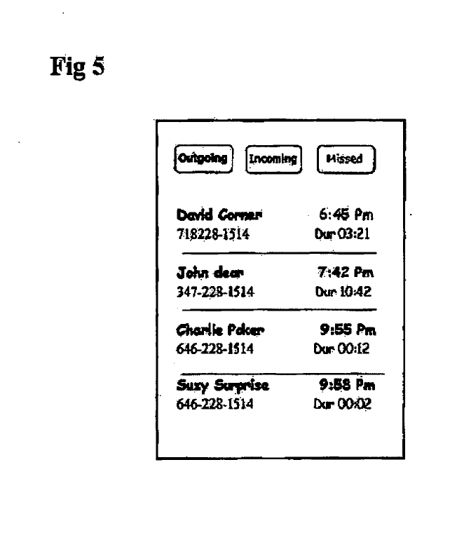

An example of the usage of such swipe gestures can be seen with respect to FIG. 5 the user is swiping over N elements but now the elements are located in elliptic shape. By swiping clockwise over part of the elements the user generates additional results except for the regular results generated by tapping on the elements. More results can be achieved by swipe gesturing over the shape counterclockwise.

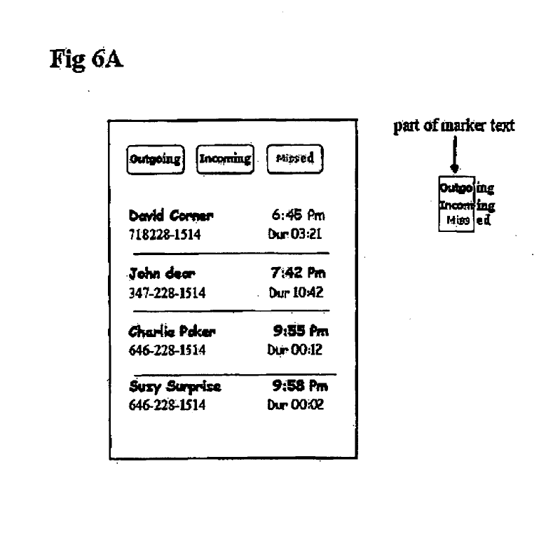

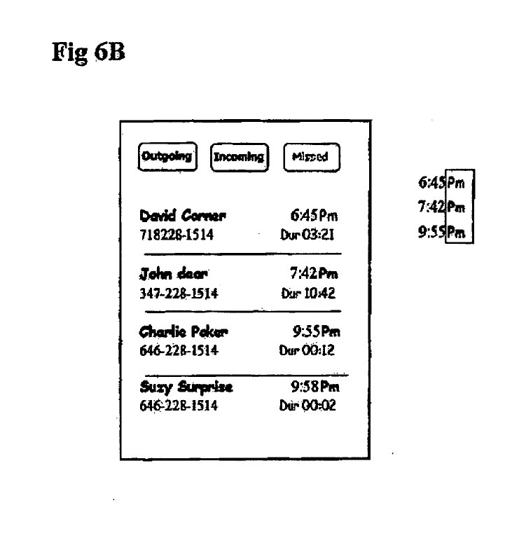

As illustrated in FIG. 6, the user can swipe gesture over N elements but now the elements located in half circle shape or in half elliptic shape. By swiping clockwise over part of the elements or over all of them the user can generate additional results except of the regular results generated by tapping on the elements. The user can swipe over the elements counterclockwise and generate additional results.

As illustrated in FIG. 7, the user can swipe gesture over N elements but now the elements are located in curve line. By swipe over part of the elements the user generates additional results except of the regular tappable results. Performing the same swipe in the opposite order can generate additional results.

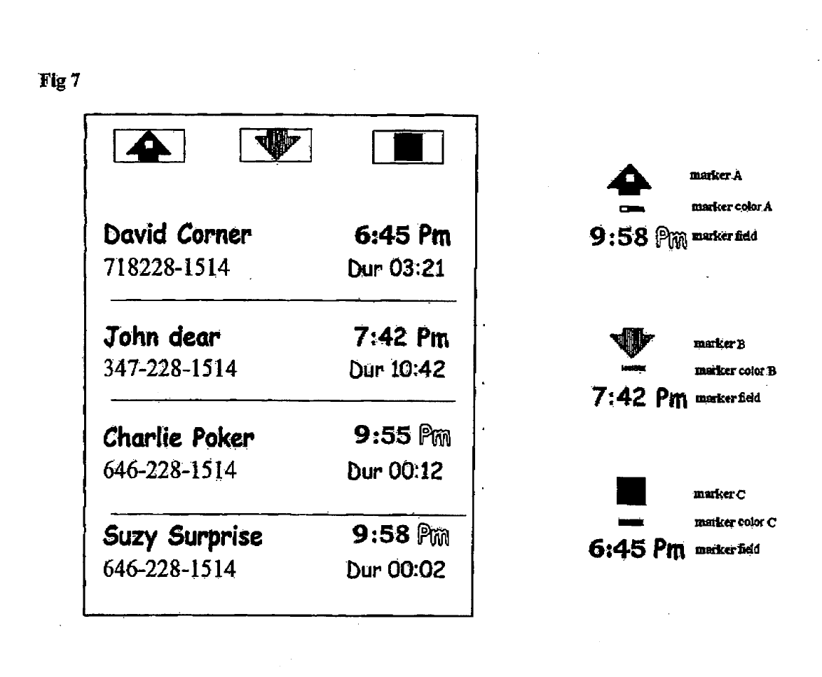

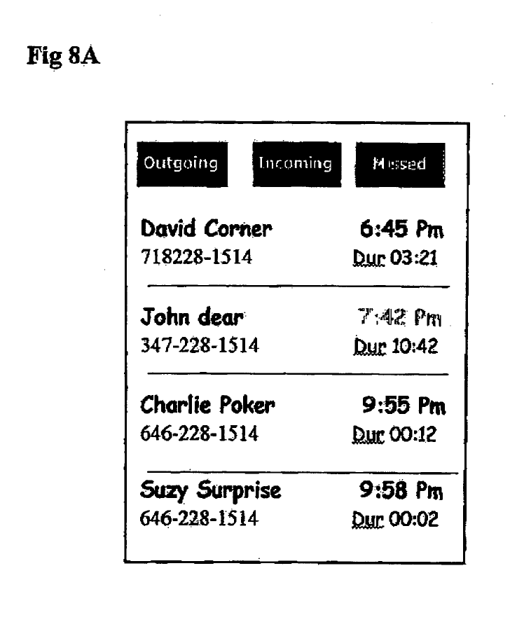

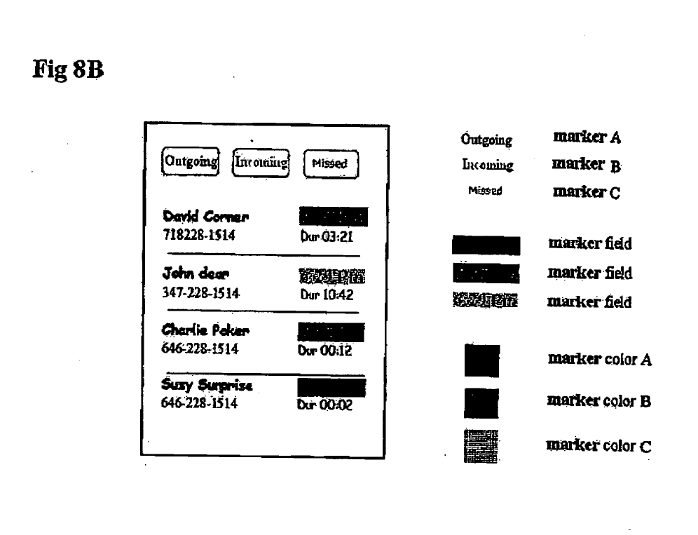

FIG. 8 describes operators applying on or between results and over a number of results that generate by tapping on N tappable elements.

The operation can be a single arithmetical operation or sequence of arithmetical operations. The operation can be a single logical operation or a sequence of logical operations. The operation can be a single group set operation or a sequence of group set operations. The operation can be a Boolean operation or sequence of Boolean operations. The operation can be any visual operation or sequence of visual operations like zoom in/out, size, location, focus stretch rotate brighten or any visual processing. In records result set the operation can be sort order filter or group. The operation can be a combination between all operations described above and a combination between them and between themselves.

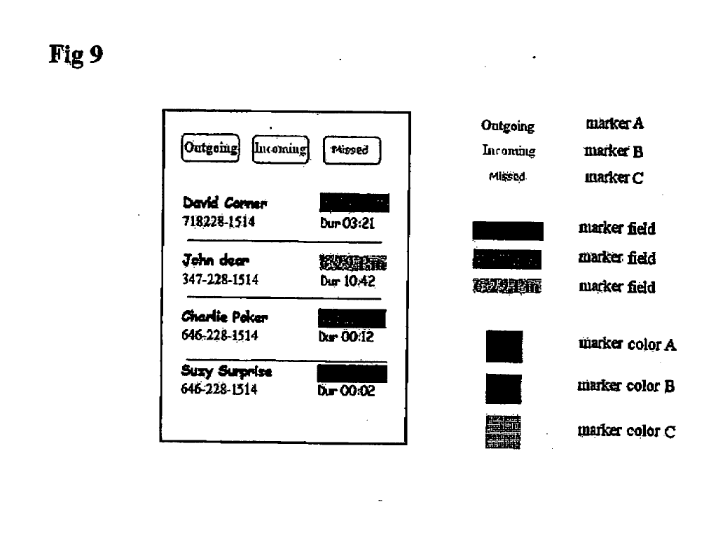

The result's definition of a swipe gesture over N tappable elements is described in FIG. 9. A simple result is accepted by applying operation between results or on results between actions or on actions. To achieve a complicated result we can chain operations on and between results or actions.

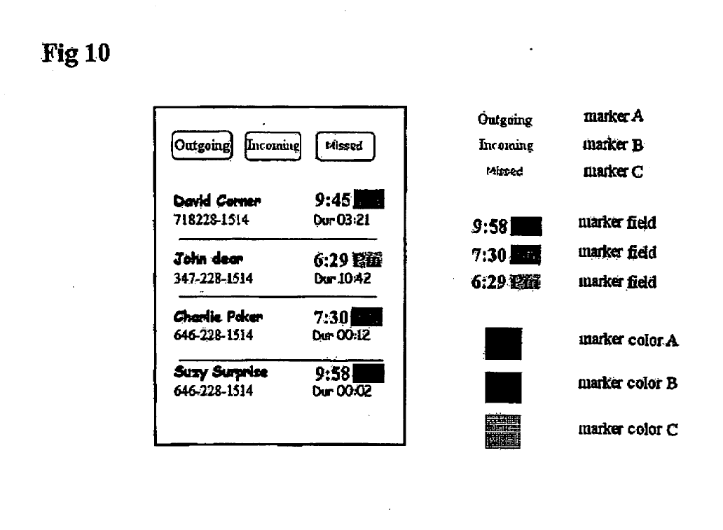

FIG. 10 describes a formula for the X additional results that can be achieved in the present innovation. This is a general formula for N tappable elements. An example of the usage of this formula can be seen in FIG 10.

In this example the number of elements is three. The additional possible results generated by this innovation are four except for the three regular results.

An example computer system that can implement swipe gestures as described above is illustrated in the simplified schematic of FIG. 11. The program may be stored in a memory 105 of the computer system, including solid state memory (RAM, ROM, etc.), hard drive memory, or other suitable memory. CPU 104 may retrieve and execute the program. CPU 104 may also receive input through a multi-touch interface 101 or other input devices not shown. In some embodiments, I/O processor 103 may perform some level of processing on the inputs before they are passed to CPU 104. CPU 104 may also convey information to the user through display 102. Again, in some embodiments, an I/O processor 103 may perform some or all of the graphics manipulations to offload computation from CPU 104. Also, in some embodiments, multi-touch interface 101 and display 102 may be integrated into a single device, e.g., a touch screen.

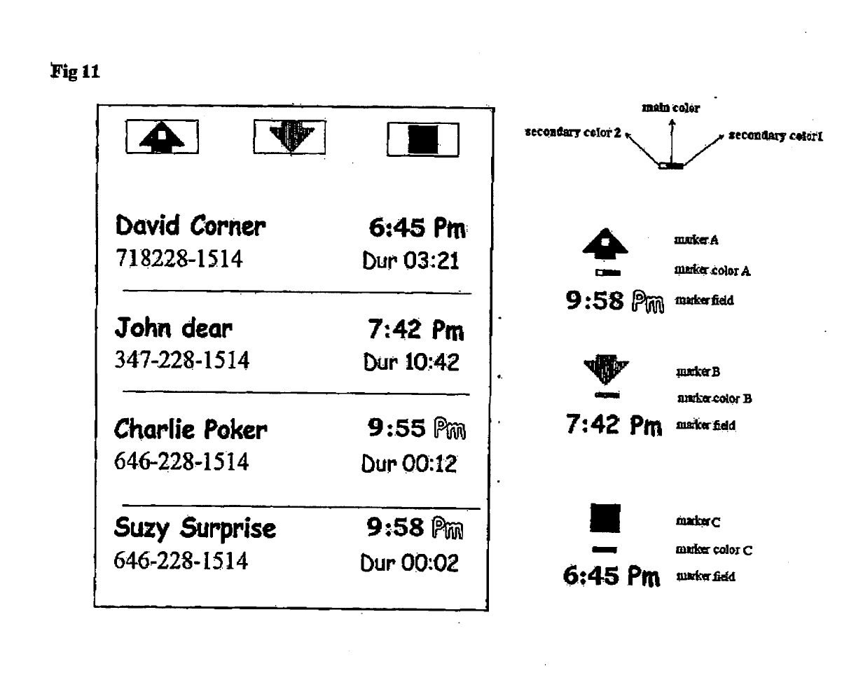

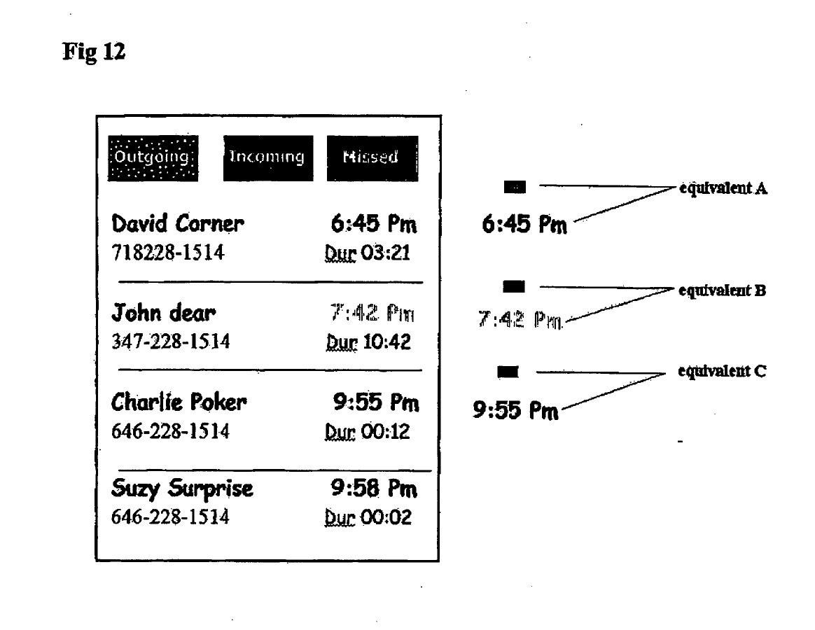

The computer system may be any of a variety of types illustrated in FIG. 12, including tablet computers 201, desktop computers 202, notebook computers 203, handheld computers 204, personal digital assistants 205, media players 206, mobile telephones 207, and the like. Additionally, the computer may be a combination of these types, for example, a device that is a combination of a personal digital assistant, media player, and mobile telephone.

Further modifications and alternative embodiments will be apparent to those skilled in the art in view of this disclosure. For example, although the foregoing description has discussed touch screen applications in handheld devices, the techniques described are equally applicable to touch pads or other touch-sensitive devices and larger form factor devices. Accordingly, this description is to be construed as illustrative only and is for the purpose of teaching those skilled in the art the manner of carrying out the invention. It is to be understood that the forms of the invention herein shown and described are to be taken as exemplary embodiments. Various modifications may be made without departing from the scope of the invention.

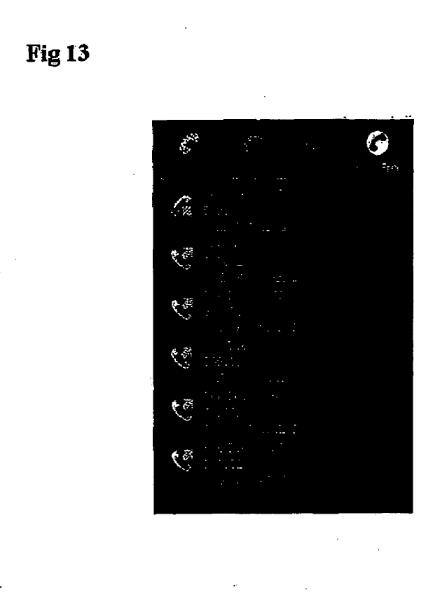

A data base application that uses swipe gestures over three tappable elements can be seen with respect to FIG 13. Tapping on “outgoing” button shows outgoing calls. Tapping on “incoming” button shows incoming calls. Tap on “missed” button shows missed calls. Swipe gesture over the three buttons rather then using additional button “All” to perform the same actions showing all of the calls. A union from “group set” is the operation that was applied between the results. Order by datetime is the operation that was applied over all results. As we can see a additional button has been saved. Only one result was needed from the four possible results of a swipe gesture combination in this data base application. Therefore the user doesn't need to swipe over all buttons as described in FIG. 13 and yet we get the same swipe gesture result.

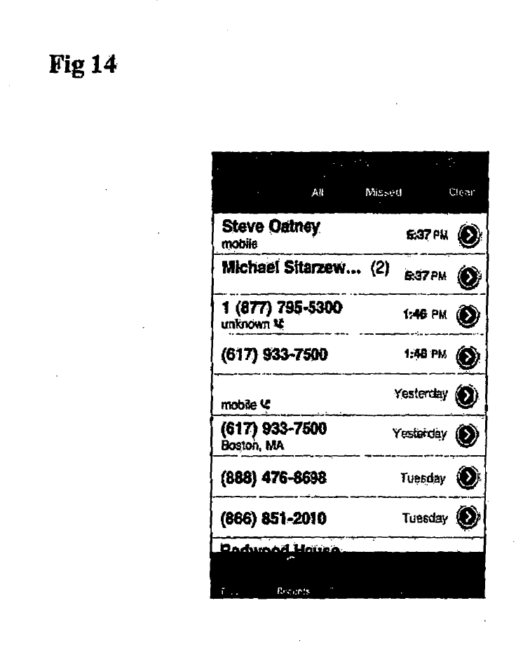

A three dimensional application that uses swipe gestures over tappable elements can be seen with respect to FIGS. 14A and 14B. Tapping on any country picture will load the map of the country to the globe. In this present innovation swipe gestures over several countries will load the maps of these countries without using additional elements. The operations applying on the results are a “union” from groups-set and “zoom in/out” from visual operations. Union operations apply between the results. Zoom in/out operations apply on the results as described in FIG. 14B.

Implementation of present patent illustrated properly in FIGS. 15A-15C. The media control in FIG. 15A represents picture video sound and all kinds of media. Numbers of tappable elements are four. By tapping on element media is loaded into the control. By a left to right swipe gesture over N elements when N bigger then one N media are loaded without using additional buttons as described in FIG. 15B. Hear the operation work on elements between elements and over all elements.

A different result can be achieved by a swipe gesture over the same elements A and B but in opposite order as described in FIG. 15C instead of adding two video we omit them.

1. A method of interpreting one or more swipe gestures over multiple visual tappable elements to generate results based on actions or results of all the visual tappable elements included under the one or more swipe gestures, comprising: detection of swipe gestures, determining their direction and detection of visual elements involved and then performing an action which is a function of direction flow and visual tappable elements involved.

2. The method of claim 1 wherein the visual tappable elements are on Touched screen elements each of which are programmed to perform some action when tapped.

3. The method of claim 2 wherein the swipe gesture result is a result of a swipe gesture over N visual tappable elements, where N equals or greater than 2.

4. The method of claim 1 wherein the result of the one or more swipe gestures is arrived at by applying an operator on or between actions of tapping on N tappable elements.

5. The method of claim 1 wherein the result of the one or more swipe gestures is arrived at by applying an operator on or between results of tapping on N tappable elements.

6. The method of claim 2 wherein the on-screen elements are selected from a group consisting of: buttons, picture-buttons, pictures, icons, or visual objects which generate events or actions when tapped.

7. The method of claim 5 wherein the operation is a single or sequence of arithmetical, logical, or group-set operations or visual operations, like zoom in/out, size, location, and focus.

8. The method of claim 1 wherein the direction of the swipe-gestures can change the operation performed.

9. The swipe gesture over multiple tappable elements in claim 1 can optionally provide feedback indicating the function performed.

10. The method of claim 1 wherein the swipe gesture is a single-finger swipe gesture or multi-finger swipe gesture.

11. The method of claim 8 wherein the direction can be rightward, leftward, downward or upward swipe gesture.

12. The method of claim 1 wherein the tappable elements include at least two elements.

13. A computer system having a processor operatively coupled to a memory and a multi-touch interface, the multi-touch interface comprising a tappable-elements area in which taps of a touch object generate an action, the computer system being adapted to: detect a swipe gesture across the tappable-elements; determine a direction of the swipe gesture: and perform a predetermined function determined by the direction of the swipe gesture without regard to an initial touchdown point of the swipe gesture.

14. The computer system of claim 13 wherein the computer system is selected from the group consisting of a desktop computer, a tablet computer, and a notebook computer.

15. The computer system of claim 13 wherein the computer system comprises at least one of a handheld computer, a personal digital assistant, a media player, and a mobile telephone.

16. The computer system of claim 13 wherein the multi-touch interface is a touch screen.
